(19) United States
(12) Patent Application Publication
(10) Pub. No.: US 2005/0237484 A1
(43) Pub. Date: Oct. 27, 2005

(54) Colored contact lens with a more natural appearance

(76) Inventor: Gerardo J. Ocampo, Bridgeview, IL (US)

Correspondence Address: Jeffrey A. Pine;BANIAK PINE & GANNON, Suite 1200, 150 N. Wacker Drive, Chicago, IL, 60606-1606, US

(21) Appl. No.: 11/168,109

(22) Filed: Jun. 28, 2005

Related U.S. Application Data
(63) Continuation of application No. 10/987,753, filed on Nov. 12, 2004.
Application No. 10/987,753 is a continuation of application No. 10/403,920, filed on Mar. 31, 2003, now abandoned.
Application No. 10/403,920 is a continuation of application No. 10/234,761, filed on Sep. 4, 2002, now abandoned.
Application No. 10/234,761 is a continuation of application No. 09/624,667, filed on Jul. 24, 2000, now abandoned.
Application No. 09/624,667 is a continuation of application No. 09/144,479, filed on Aug. 31, 1998, now abandoned.
(60) Provisional application No. 60/077,829, filed on Mar. 12, 1998.

(51) Int. Cl. G02C 7/04

(52) U.S. Cl. 351/162

(57) ABSTRACT

A colored contact lens having a non-opaque pupil section, an iris section surrounding said pupil section, and, opaque, intermittent pattern over the iris section which is indiscernible to the ordinary viewer. The pattern is made up of a first portion having a first shade, a second portion having a second shade different from the first shade, and a third portion having a shade different from the second portion and either the same or different from the first portion. A first uneven border differentiates the first and second portions, and a second uneven border differentiates the second and third portions, however, said portions may overlap. The lens is capable of changing appearance of the iris of the person wearing the lens.

This application is based on pending prior Provisional Application No. 60/077,829, filed on Mar. 12, 1998. Priority is based thereon.

### TECHNICAL FIELD

The present invention relates to colored contact lenses and in particular to such lenses having opaque colored portions that are able to change the apparent color of the wearer's iris while imparting a very natural appearance.

### BACKGROUND OF THE INVENTION

Early attempts to modify or enhance the color of one's eyes utilized colored contact lenses with a simple solidly colored area that covered the iris of the users eyes. However, contact lenses with this type of opaque coloring imparted a very unnatural appearance. Other types of colored contact lenses were developed, such as Wichterle, U.S. Pat. No. 3,679,504, which discloses an opaque lens having an iris of more than a single color artistically drawn or photographically reproduced. However, such lenses never achieved commercial success. Other attempts to produce an opaque lens with a natural appearance are disclosed in. U.S. Pat. No. 3,536,386, (Spivak); U.S. Pat. No. 3,712,718 (LeGrand), U.S. Pat. No. 4,460,523 (Neefe), U.S. Pat. No. 4,719,657 (Bawa), U.S. Pat. No. 4,744,647 (Meshel et al.), U.S. Pat. No. 4,634,449 (Jenkins); European Patent Publication No. 0 309 154 (Allergan) and U.K. Patent Application No. 2 202 540 A (IGEL).

Commercial success was achieved by the colored contact lens described in Knapp (in U.S. Pat. No. 4,582,402) which discloses a contact lens having, in its preferred embodiment, colored, opaque dots. The Knapp lens provides a natural appearance with a lens that is simple and inexpensive to produce, using a simple one-color printed dot pattern. Although the intermittent pattern of dots does not fully cover the iris, it provides a sufficient density of dots that a masking effect gives the appearance of a continuous color when viewed by an ordinary observer. Knapp also discloses that the printing step may be repeated one or more-times using different patterns in different colors, since upon close examination the iris's of many persons are found to contain more than one color. The printed pattern need not be absolutely uniform, allowing for enhancement of the fine structure of the iris. The one color Knapp lenses currently achieving commercial success have their dots arranged in an irregular pattern to enhance the structure of the iris. However, neither the Knapp commercial lenses, nor the Knapp patent disclose or suggest how one would arrange a pattern of dots having more than one color to achieve a more natural appearance.

Various efforts have been made to improve on the Knapp lens. U.S. Pat. No. 5,414,477 to Jahnke discloses the application of the intermittent ink pattern in two or more portions of distinct shades of colorant to provide a more natural appearance.

Other attempts to create a more natural appearing lens include U.S. Pat. No. 5,120,121 to Rawlings which discloses a cluster of interconnecting lines radiating from the periphery of the pupil portion to the periphery of the iris portion. Further, European Patent No. 0 472 496 A2 shows a contact lens having a pattern of lines that attempts to replicate the lines found in the iris.

Despite these efforts, the contact lens industry continues to seek a low-cost, colored lens that can enhance or modify the eye color, while providing the depth and texture that is inherent in the human iris.

### SUMMARY OF THE INVENTION

The present invention is based on the surprising discovery that multiple-color opaque patterns can achieve a more natural appearing iris if configured properly. The improvement in appearance over the one-color Knapp lenses and the two color Jahnke lenses is startling. Like the one and two color lenses, the lenses of this invention are able to cause a fundamental change in the apparent color of the wearer's iris, e.g. from dark brown to light blue or green. Although the preferred embodiment of the invention is a three color lens wherein different colors overlap, more than three colors are contemplated, and lenses wherein all three (or more) of the different colors overlap are also contemplated.

One objective of the invention is to provide a colored contact lens with a non-opaque pupil section, an iris section surrounding the pupil section, and a colored, opaque intermittent pattern over the iris section. The elements of the pattern are indiscernible to the ordinary viewer and are made up of a first portion of the elements of the pattern, or the outermost starburst, which is a first shade, and a second portion of the elements of the pattern or the outer starburst, which is a second shade different from said first shade, and a third portion of the elements of the pattern, or the inner starburst, which is a third shade different from said first shade and either different or the same as the second shade. The outermost starburst is located generally on the outside of the iris section and generally outside of the outer starburst, and the outer starburst is located generally on the outside of the inner starburst. A first uneven border differentiates the outermost and outer starbursts, although there is overlap of the outermost and outer starbursts. A second uneven border differentiates the outer and inner starbursts, although there is overlap between the outer and inner starbursts. Thus, a lens capable of changing the apparent color of the iris of a person wearing the lens and imparting a very natural appearance is provided.

Another objective of the invention is to provide a colored contact lens with a non-opaque pupil section, an iris section surrounding the pupil section, and a colored, opaque intermittent pattern over the iris section, that leaves a substantial portion within the interstices of the pattern non-opaque. The pattern covers at least about 25 percent of the area of the iris section. The elements of the pattern are indiscernible to the ordinary viewer. A first portion of the elements of the pattern, or the outermost starburst, is of a first shade, and a second portion of the elements of the pattern, or the outer starburst, is of a second shade different from said first shade, and a third portion of the elements of the pattern, or the inner starburst, is of a third shade different from said first shade and either different or the same as the second shade. The outermost starburst is located generally on the outside of iris section and generally on the outside of the outer starburst, and the outer starburst is located generally on the outside of the inner starburst. A first uneven border differentiates the outermost and outer starbursts although the outermost and outer starbursts overlap, and a second uneven border differentiates the outer and inner starbursts although the outer and inner starbursts overlap. The minimum distance of the first uneven border from the outer perimeter of said iris section is from about 5% to about 60% of the radial width of said iris section. The maximum distance of the first uneven border from the outer perimeter of said iris section is from about 25% to about 95% of the radial width of the iris section. The minimum distance of the second uneven border from the outer perimeter of the iris section is from about 15% to about 75% of the radial width of the iris section, and the maximum distance of said second uneven border from the outer perimeter of the iris section is from about 50% to about 95% of the radial width of the iris section. Thus, a contact lens capable of changing the apparent color of the iris of a person wearing the lens and imparting a very natural appearance is provided.

Another objective of the invention is to provide a colored contact lens with a non-opaque pupil section, an iris section surrounding the pupil section, and a colored, opaque intermittent pattern over the iris section, that leaves a substantial portion within the interstices of the pattern non-opaque. The pattern covers at least about 25 percent of the area of the iris section. The elements of the pattern are indiscernible to the ordinary viewer. A first portion of the elements of the pattern, or the outermost starburst, is of a first shade, and a second portion of the elements of the pattern, or the outer starburst, is of a second shade different from said first shade, and a third portion of the elements of the pattern, or the inner starburst, is of a third shade different from said first shade and either different or the same as the second shade. The outermost starburst is located generally on the outside of iris section and generally on the outside of the outer starburst, and the outer starburst is located generally on the outside of the inner starburst. A first uneven border differentiates the outermost and outer starbursts although the outermost and outer starbursts overlap, and a second uneven border differentiates the outer and inner starbursts although the outer and inner starbursts overlap. The minimum distance of the first uneven border from the outer perimeter of said iris section is from about 15% to about 50% of the radial width of said iris section. The maximum distance of the first uneven border from the outer perimeter of said iris section is from about 45% to about 95% of the radial width of the iris section. The minimum distance of the second uneven border from the outer perimeter of the iris section is from about 15% to about 65% of the radial width of the iris section, and the maximum distance of said second uneven border from the outer perimeter of the iris section is from about 60% to about 95% of the radial width of the iris section. Thus, a contact lens capable of changing the apparent color of the iris of a person wearing the lens and imparting a very natural appearance is provided.

The term “non-opaque” as used herein is intended to describe a part of the lens that is uncolored or colored with translucent coloring.

The term “second shade different from said first shade” (or some similar language) as used herein is intended to mean that both shades are of totally different colors, such as blue and hazel; or that both shades are the same basic color, but having different intensities such as light blue and dark blue.

The term “ordinary viewer” is intended to mean a person having normal 20-20 vision standing about 5 feet from a person wearing the lenses of this invention.

### BRIEF DESCRIPTION OF THE DRAWINGS

FIG. 1 illustrates a contact lens pattern in accordance with the present invention;

FIG. 2 illustrates a contact lens pattern indicating an outermost starburst in accordance with the present invention;

FIG. 3 illustrates a contact lens pattern indicating an outer starburst in accordance with the present invention;

FIG. 4 illustrates a contact lens pattern indicating an inner starburst in accordance with the present invention;

### DETAILED DESCRIPTION OF THE PREFERRED EMBODIMENTS

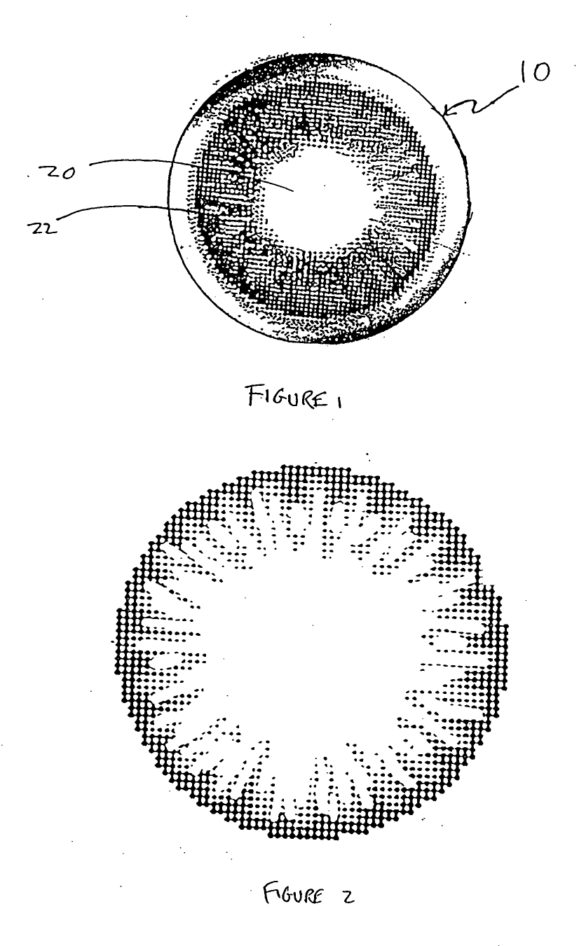

FIG. 1 shows a contact lens 10 in accordance with the present invention. It has a non-opaque pupil section 20 in the center of lens, and an annular iris section 22 surrounding the pupil section. For hydrophilic lenses a peripheral section (not shown) surrounds iris section 22. A colored, opaque, intermittent pattern is located over the iris section 22, as show in FIG. 1. The pattern leaves a substantial portion of the iris section within the interstices of the pattern non-opaque. The non-opaque areas of the iris section 22 appear white in FIG. 1. The elements of the pattern are preferably dots, and especially preferred are dots, some of which run together, as shown in FIG. 1. Certain portions of the iris section 22 are less densely covered with dots than other portions. The less densely covered portions form approximately radial spokes. This arrangement enhances the structure of the iris of a person wearing the lens.

Of course, the opaque pattern may be comprised of dots having any shape, regular or irregular, such as round, square, hexagonal, elongated, etc. Further, the elements of the pattern may have a shape other than dots, so long as the elements are indiscernible to the ordinary viewer, cover at least about 25 percent of the iris, and leave a substantial portion of the iris section within the interstices of the pattern non-opaque.

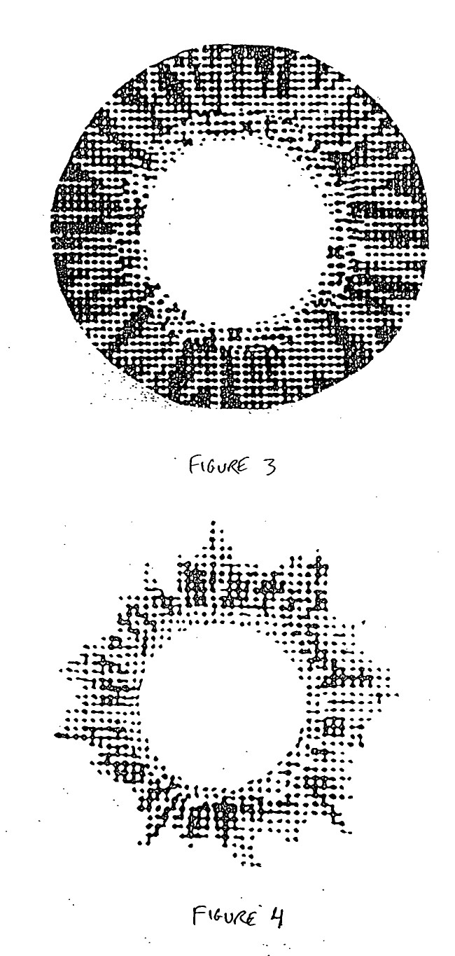

The improvement of this invention is a multiple color pattern that greatly improves the natural appearance of the wearer's iris, even over that of one and two color lenses. To produce this three (or more) color pattern, dots (or some other element) are printed in three or more portions or color zones. A first portion of the elements are of a first shade and are located generally on the outside of the iris section, i.e. at or near the outer perimeter of the annular iris section, and may be referred to as the outermost starburst. A preferable first outside portion pattern or outermost starburst is shown in FIG. 2. Black is most often used as the color of the outermost starburst. A second portion of the elements are of a second shade different from the first shade and are located generally on the inside of the outermost starburst, and generally surrounded by the outermost starburst portion. A preferable second inside portion pattern or outer starburst appears in FIG. 3. The outer starburst can be many colors, for example, blue, gray, brown or green. A third portion of the elements are of a third shade different from the second shade and either the same or different from the first shade are located generally on the inside of the outer starburst, and generally surrounded by the outer starburst portion. A preferable third inside portion pattern or inner starburst appears in FIG. 4. The preferred color for the inner starburst is hazel. FIG. 1, the preferred embodiment of the present invention, shows a combination of FIGS. 2, 3 and 4.

A first uneven border differentiates the outermost starburst and the outer starburst portions of the pattern elements, however, the outermost and outer starbursts overlap. A second uneven border differentiates the outer starburst and the inner starburst portions of the pattern, however, the outer and inner starbursts overlap. If the patterns of FIGS. 2, 3 and 4 are merged to form a three color lens, the uneven edge of the pattern shown in FIG. 2 will merge and overlap with the pattern shown in FIG. 3 to form the first uneven border between the outermost and outer starbursts. Further, the uneven edge of the pattern shown in FIG. 4 will merge and overlap with the pattern shown in FIG. 3 to form the second uneven border between the outer and inner starbursts.

In certain cases, the outer starburst may contain pattern that extends further toward the periphery of the lens than the pattern of the outermost starburst. In certain cases, the outer starburst may contain pattern that extends further toward the pupil section of the lens than the pattern of the inner starburst.

Alternative embodiments of the present invention include minimum and maximum distances of the uneven borders from the outer perimeter of the iris section. For example in one alternative embodiment, the minimum distance of the first uneven border from the outer perimeter of the iris section is from about 5% to about 60% of the radial width of the iris section, and the maximum distance of the uneven border from the outer perimeter of the iris section is from about 25% to about 95% of the radial width of the iris section, and the minimum distance of the second uneven border from the outer perimeter of the iris section is from about 15% to about 75% of the radial width of the iris section, and the maximum distance of the uneven border from the outer perimeter of the iris section is from about 50% to about 95% of the radial width of the iris section.

In another embodiment, the minimum distance of the first uneven border from the outer perimeter of the iris section is from about 15% to about 50% of the radial width of the iris section, and the maximum distance of the uneven border from the outer perimeter of the iris section is from about 45% to about 95% of the radial width of the iris section, and the minimum distance of the second uneven border from the outer perimeter of the iris section is from about 15% to about 65% of the radial width of the iris section, and the maximum distance of the uneven border from the outer perimeter of the iris section is from about 60% to about 95% of the radial width of the iris section.

In yet another alternative embodiment, the outer starburst pattern stretches closer to the periphery of the contact lens than the outermost starburst pattern, and/or the outer starburst pattern stretches closer to the pupil section than the inner starburst pattern.

In yet another alternative embodiment, the inner starburst pattern creates an interdigitation configuration with either the outermost starburst pattern or the outer starburst pattern or both patterns. Further, the outermost starburst pattern may create a interdigitation configuration with the outer starburst pattern. In an interdigitation configuration, one pattern intersects another similar to the fingers on one hand placed between the fingers on the other hand in a planar fashion. Further, a fourth zone may be utilized in which the fourth zone is the same or different color as the second zone. The fourth zone is interdigitated with the third zone.

Producing the opaque portions of the iris section is preferably accomplished by printing the lens three times using the known printing process of Knapp's U.S. Pat. No. 4,582,402, incorporated herein by reference, and the known printing process of Rawling's U.S. Pat. Nos. 5,034,166 and 5,116,112, incorporated herein by reference. Generally, a plate or cliché having depressions in the desired pattern is smeared with ink of the desired shade. Excess ink is removed by scrapping the surface of the plate with a doctor blade leaving the depression filled with ink. A silicon rubber pad is pressed against the plate to pick up the ink from the depressions and then is pressed against a surface of the lens to transfer the pattern to the lens. The printed pattern is then cured to render it unremovable from the lens. Of course, either the anterior or posterior surfaces of the lens may be printed, but printing the anterior surface is presently preferred.

The preferred lenses and ink ingredients used to practice this invention are known and described in Loshaek's U.S. Pat. No. 4,668,240, incorporated herein by reference. The specific ingredients and target weights are described in detail below. Very briefly, a lens constructed of polymer having —COOH, —OH, or —NH₂ groups is printed with ink containing binding polymer having the same functional groups, opaque coloring substance, and a diisocyanate compound. First a mixture of pigments and solvent is ground milled, and binder polymer(s) are mixed with it to form a paste. A mixture of monomers and hexamethylene diisocyanate is added to form an ink The preferred binding polymer solutions have a viscosity of about 35,000 CPS for blue, gray, brown and black, and 50,000 CPS for green. The opaque ink is printed and cured on the lens surface.

Ink pastes and pigments which can be utilized in the present invention can be made in a number of different ways utilizing the ingredients and percentages (by weight) as described below in the ink color charts. For example, a hazel ink paste can be made using 63.49 percent binder solution (by weight), 30.00 percent ethyl lactate, 0.61 percent titanium dioxide, 0.06 percent PCN blue, 4.30 percent iron oxide yellow, and 1.54 percent iron oxide red. Although these colors are used for the preferred embodiments, other colors or variations of the weight percentage of ingredients may be used. The charts below are merely a representative example of the possible pastes and pigment levels, and is not a complete list. One having ordinary skill in the art could develop other pastes and pigment levels that would provide an enhancing effect to the iris of a person wearing the contact lens.

| | INK PASTE COLOR CODE | | | | | |
|---|---|---|---|---|---|---|
| | BLUE | | | GRAY | | |
| Total Wt. (g) | | 600 | 3000 | | 600 | 3000 |
| | Weight | Target | Target | Weight | Target | Target |
| Ingredient | Percent | Weight | Weight | Percent | Weight | Weight |
| Ethyl Lactate | 30.55 | 183.30 | 916.50 | 30.75 | 184.50 | 922.50 |
| Binder Soln | 61.15 | 366.90 | 1834.50 | 59.84 | 359.10 | 1795.50 |
| PCN Blue | 1.21 | 7.26 | 36.30 | | | |
| PCN Green | | | | 0.23 | 1.38 | 6.90 |
| TiO₂ | 7.09 | 42.54 | 212.70 | 7.34 | 44.04 | 220.20 |
| IO Black | | | | 1.83 | 10.98 | 54.90 |
| IO Red | | | | | | |
| IO Yellow | | | | | | |
| IO Brown | | | | | | |
| Grinding | | 600 | 3000 | | 600 | 3000 |
| Media | | | | | | |
| | INK PASTE COLOR | | | | | |
| | BROWN | | | HAZEL | | |
| Total Wt. (g) | | 651 | 3000 | | 651 | 3000 |
| | Weight | Target | Target | Weight | Target | Target |
| Ingredient | Percent | Percent | Weight | Percent | Weight | Weight |
| Ethyl Lactate | 30.00 | 180.00 | 900.00 | 30.00 | 180.00 | 900.00 |
| Binder Soln | 55.10 | 330.60 | 1653.00 | 63.49 | 380.94 | 1904.70 |
| PCN Blue | | | | 0.06 | 0.36 | 1.80 |
| PCN Green | | | | | | |
| TiO₂ | | | | 0.61 | 3.65 | 18.3 |
| IO Black | 5.70 | 34.20 | 171.00 | | | |
| IO Red | 3.45 | 20.70 | 103.50 | 1.54 | 9.25 | 46.20 |
| IO Yellow | | | | 4.30 | 25.80 | 129.00 |
| IO Brown | 5.75 | 34.50 | 172.50 | | | |
| Grinding | | 600 | 3000 | | 600 | 3000 |
| Media | | | | | | |
| | INK PASTE COLOR | | | | | |
| | GREEN | | | BLACK | | |
| Total Wt. (g) | | 651 | 3000 | | 651 | 3000 |
| | Weight | Target | Target | Weight | Target | Target |
| Ingredient | Percent | Weight | Weight | Percent | Weight | Weight |
| Ethyl Lactate | 28.53 | 185.73 | 855.90 | 23.98 | 156.11 | 719.40 |
| Binder Soln | 63.85 | 415.66 | 1915.50 | 64.04 | 416.90 | 1921.20 |
| PCN Blue | 0.03 | 0.20 | 0.90 | | | |
| PCN Green | | | | | | |
| TiO₂ | | | | | | |
| IO Black | | | | 11.98 | 77.99 | 35.94 |
| IO Red | | | | | | |
| IO Yellow | | | | | | |
| Cr₂O₂ | 7.59 | 49.41 | 227.70 | | | |
| IO Brown | | | | | | |
| Grinding | | 850 | 4298 | | 850 | 4298 |
| Media | | | | | | |

Of course, alternative ways to form colored opaque elements of the lens may be used. For example, selected portions of the iris section of a wetted hydrophilic lens may be impregnated with a solution of a first substance, such as barium chloride. Then the lens may be immersed in a solution of a second substance, such as sulfuric acid, that forms an opaque, water-insoluble precipitate with the first substance, for example barium sulfate. Thus an opaque precipitate forms within the lens in a predetermined pattern in the iris section. Next all or at least the opaque pattern of the iris section is colored opaque pattern in accordance with the invention. If the entire iris is colored with translucent tint, then the interstices within the pattern will be translucently colored, but still non-opaque and in accordance with the preferred embodiment of the present invention. Optionally, the pupil section of the lens may be colored by a non-opaque tint, because such tint is not visible when the lens is against the dark pupil present in the eye of the wearer. Other alternative opaquing methods include use of a laser (U.S. Pat. No. 4,744,647) and finely ground particles U.S. Pat. No. 4,460,523.

The process of the present invention for making colored contact lenses is as follows. A transparent contact lens comprising at least a pupil section and an iris section surrounding the pupil section is provided.

If the lens is constructed of a hydrophilic material, it also has a peripheral section surrounding iris section. For hydrophilic material, the steps described below are performed with the material in an unhydrated state. Preferred hydrophilic materials are disclosed by Loshaek in U.S. Pat. No. 4,405,773, incorporated herein by reference.

The colored pattern may be deposited onto iris section of the lens in any manner. The currently preferred method is by offset pad printing, described below in some detail.

A plate (not shown) is prepared having flat surface and circular depressions corresponding to the desired dot pattern. The depressions are arranged to cover an annular shape corresponding to that of the iris section of the lens.

The plate may be made by a technique that is well known for making integrated analog or digital circuits. First a pattern about 20 times as large as the desired pattern is prepared. Next the pattern is reduced using well known photographic techniques to a pattern of the exact desired size having the portion to be colored darker than the remaining area. A flat surface is covered by a photo resist material which becomes water insoluble when exposed to light. The photo resist material is covered with the pattern and exposed to light. The portion of the photo resist pattern is removed by washing with water and the resulting plate is etched to the required depth. Then the remainder of the photo resist material is mechanically removed.

Colorant, comprising a pigment and binder or carrier for the pigment and an adhesion promoter, is deposited on a flat surface of the plate and scraped across the pattern with a doctor blade. This causes depressions to be filled with ink while removing excess ink from flat surface. The colorant may be more or less opaque depending on the degree of color change desired. The opacity may be varied by modifying the proportion of pigment to binder in the colorant. It will be recognized that a desired affect may be obtained using a highly opaque colorant or by having a somewhat less opaque colorant and covering a greater portion of the iris section surface.

A pad made of silicon rubber, impregnated with silicon oil for easy release, is pressed against the pattern, removing ink from depressions. The ink on the pad is allowed to dry slightly to improve tackiness, then pressed against the front surface of the contact lens, depositing the ink in the desired pattern over the iris section. Of course the pad must have enough flexibility to deform to fit over the convex front surface of the lens. The printed pattern need not be absolutely uniform, allowing for enhancement of the fine structure of the iris.

Next the deposited pattern is treated to render it resistant to removal from the lens under exposure to the ocular fluids that the lens will encounter when placed in the eye. The exact method of preventing removal depends on the material of construction of the lens and the pattern. Mere air drying or heating the lens at, for example, 85° C. for 45 minutes, would suffice. For hydrophilic lenses, the techniques for coating the opaque pattern described in Loshaek U.S. Pat. No. 4,668,240 (incorporated herein by reference), may be used.

The method for manufacturing a colored contact lens in accordance with the present invention generally includes the steps of applying three portions of colorant to the surface of a transparent contact lens and rendering the colorant resistant to removal from ocular fluids. The printed contact lens will have a non-opaque pupil section and an iris section surrounding said pupil section with the three portions of colorant. The first portion of colorant, or outermost starburst, is of a first shade, the second portion of colorant, the outer starburst, is a second shade which is different than the first shade, and the third portion of the colorant, or the inner starburst, is a third shade which is different than the second shade and may or may not be the same as the first shade. The outermost starburst will be located generally on the outside of the iris section and generally on outside of the outer starburst, the outer starburst will be located generally on the outside of the inner starburst, and a first uneven border will differentiate the outermost starburst and the outer starburst although the outermost starburst and the outer starburst potions will overlap, a second uneven border will differentiate the outer starburst and the inner starburst although the outer and inner starbursts will overlap. Thus, a lens capable of changing the apparent color of the iris of a person wearing the lens and imparting a very natural appearance will be provided.

The steps used in order to deposit the intermittent pattern on the lens surface include using a first plate having depressions corresponding to the first portion or outermost starburst and filling the depressions with colorant of the first shade, preferably black. Then, pressing a first flexible pad against the first plate and subsequently pressing the first flexible pad against the surface of the lens (either side) thereby printing the first portion of the elements.

Next, using a second plate having depressions corresponding to the second portion or outer starburst and filling in the depressions with colorant of the second shade which is different from the first shade, preferably blue, green, gray or brown. Next, pressing the second flexible pad against a second plate and pressing the second flexible pad against the surface of the lens (either the same or the opposite surface) thereby printing the second portion of the elements.

Finally, using a third plate having depressions corresponding to the third portion or inner starburst and filling the depressions with colorant of the third shade which is different from the second shade and is either the same or different from the first shade, preferably hazel. Pressing a third flexible pad against the third plate and pressing the third flexible pad against said surface of the lens (either side) thereby printing the third portion of the elements.

Although the steps listed above place an order to the printing of the portions on the lens, the order of printing is not important to the present invention and any other order of printing would be covered by the present invention. Further, the process described above may include the maximum and minimum distances, creating the uneven borders, previously listed in the alternative embodiments.

It can be seen that the present invention provides lenses capable of changing the appearance of the wearer's iris, while allowing visualization of the fine structure thereof. Various changes may be made in the function and arrangement of parts: equivalent means may be substituted for those illustrated and described; and certain features may be used independently from others without departing from the spirit and scope of the invention as defined in the following claims.

1. A colored contact lens comprising a non-opaque pupil section, an iris section surrounding said pupil section, and a colored, opaque intermittent pattern over said entire iris section that leaves a substantial portion within the interstices of the pattern non-opaque, said pattern covering at least about 25% of the area of said iris section, the elements of said pattern being indiscernible to the ordinary viewer, wherein a first portion of the elements of said pattern is a first shade, a second portion of the elements of said pattern is a second shade different from said first shade, and a third portion of the elements of said pattern is a third shade different from said second shade and either the same or different from said first shade, wherein said first portion is located generally on the outside of said iris section, and said second portion is located generally on the inside of said first portion, and said third portion is located generally on the inside of said second portion of said iris section, and a first uneven border differentiates said first and second portions, wherein the minimum distance of said first uneven border, created by said third portion, from the outer perimeter of said iris section is from about 5% to about 60% of the radial width of said iris section, and the maximum distance of said first uneven border from the outer perimeter of said iris section is from about 25% to about 95% of the radial width of said iris section, and a second uneven border differentiates said second and third portions, wherein the minimum distance of said second uneven border, created by said first portion, from the outer perimeter of said iris section is from about 15% to about 75% of the radial width of said iris section, and the maximum distance of said second uneven border from the outer perimeter of said iris section is from about 50% to about 95% of the radial width of said iris section, such that said first portion overlaps said second portion at a plurality of locations, and said second portion overlaps said third portion at a plurality of locations, thereby providing a lens capable of changing the apparent color of the iris of a person wearing the lens and imparting a very natural appearance.

2. The colored contact lens of claim 1 wherein the minimum distance of said first uneven border from the outer perimeter of said iris section is from about 15% to about 50% of the radial width of said iris, and the maximum distance of said first uneven border from the outer perimeter of said iris section is from about 45% to about 95% of the radial width of said iris section, and the minimum distance of said second uneven border from the outer perimeter of said iris section is from about 15% to about 65% of the radial width of said iris section, and the maximum distance of said second uneven border from the outer perimeter of said iris section is from about 60% to about 95% of the radial width of the iris section.

3. The colored contact lens in accordance with claim 1 or claim 2 wherein the elements of the pattern are dots.

4. The colored contact lens in accordance with claim 1 or claim 2 wherein the elements of the pattern are not uniform, thereby allowing enhancement of the fine structure of the iris.

5. (canceled)

6. (canceled)

7. A colored contact lens in accordance with claim 1 or claim 2 wherein said first shade is the same shade as said third shade.

8. (canceled)

9. A colored contact lens in accordance with claim 1 wherein the elements of the pattern are transparent.

10. (canceled)

11. A method for manufacturing a colored contact lens comprising providing a transparent contact lens, applying three portions of colorant to the surface of said contact lens, and rendering the colorant resistant to removal from ocular fluids, wherein the contact lens has a non-opaque pupil section and an iris section surrounding said pupil section, the improvement comprising applying the three portions of colorant, wherein a first portion of the colorant is of a first shade, and a second portion of the colorant is of a second shade which is different than the second shade, and the third portion of the colorant is of a third shade which is different than the second shade and may or may not be the same as said first shade, wherein said first portion is located generally on the outside of said iris section, said second portion is located generally on the inside of said first portion, and said third portion is located generally on the inside of said second portion, and a first uneven border differentiates said first and second portions, and a second uneven border differentiates said second and said third portions, wherein the minimum distance of said first uneven border from the outer perimeter of said iris section is from about 5% to about 60% of the radial width of said iris section, and the maximum distance of said uneven border from the outer perimeter of said iris section is from about 25% to about 95% of the radial width of said iris section, and the minimum distance of said second uneven border from the outer perimeter of said iris section is from about 15% to about 75% of the radial width of said iris section, and the maximum distance of said uneven border from the outer perimeter of said iris section is from about 50% to about 95% of the radial width of said iris section, thereby providing a lens capable of changing the apparent color of the iris of a person wearing the lens and imparting a very natural appearance, wherein the intermittent pattern is deposited on the lens surface by the steps of:
a) providing a first plate having depressions corresponding to the first portion;
b) filling the depressions with colorant of the first shade;
c) pressing a first flexible pad against the first plate;
d) pressing the first flexible pad against a surface of the lens thereby printing the first portion of the elements;
e) providing a second plate having depressions corresponding to the second portion;
f) filling in the depressions with colorant of the second shade;
g) pressing a second flexible pad against a second plate;
h) pressing the second flexible pad against said surface of the lens thereby printing the second portion of the elements;
i) providing a third plate having depressions corresponding to the third portion;
j) filling the depressions with colorant of the third shade;
k) pressing a third flexible pad against a third plate; and
l) pressing the third flexible pad against said surface of the lens thereby printing the third portion of the elements.

12. The method for manufacturing a colored contact lens in accordance with claim 11 wherein the three portions of colorant cover at least about 50% of the surface of the iris section lens.

13. The method for manufacturing a colored contact lens in accordance with claim 11 wherein the three portions of colorant cover at least about 60% of the surface of the iris section of the lens.

14. The method for manufacturing a colored contact lens in accordance with claim 11 wherein the portions of colorant cover up to 80% of the surface of the iris section of the lens.

15. The method for manufacturing a colored contact lens in accordance with claim 11 wherein the colored contact lens is hydrophilic.

16. The method for manufacturing a colored contact lens in accordance with claim 11 wherein one or more of the portions of colorant are transparent.

17. The method for manufacturing a colored contact lens in accordance with claim 11 wherein said first shade is black, said second shade is a color selected from the group consisting of blue, green, gray or brown, and said third shade is hazel.

18. A method for manufacturing a colored contact lens comprising providing a transparent contact lens, applying three portions of colorant to the surface of said contact lens, and rendering the colorant resistant to removal from ocular fluids, wherein the contact lens has a non-opaque pupil section and an iris section surrounding said pupil section, the improvement comprising applying the three portions of colorant, wherein a first portion of the colorant is of a first shade, and a second portion of the colorant is of a second shade which is different than the second shade, and the third portion of the colorant is of a third shade which is different than the second shade and may or may not be the same as said first shade, wherein said first portion is located generally on the outside of said iris section, said second portion is located generally on the inside of said first portion, and said third portion is located generally on the inside of said second portion, and a first uneven border differentiates said first and second portions, and a second uneven border differentiates said second and said third portions, wherein the minimum distance of said first uneven border from the outer perimeter of said iris section is from about 15% to about 50% of the radial width of said iris section, and the maximum distance of said uneven border from the outer perimeter of said iris section is from about 45% to about 95% of the radial width of said iris section, and the minimum distance of said second uneven border from the outer perimeter of said iris section is from about 15% to about 65% of the radial width of said iris section, and the maximum distance of said uneven border from the outer perimeter of said iris section is from about 60% to about 95% of the radial width of said iris section, thereby providing a lens capable of changing the apparent color of the iris of a person wearing the lens and imparting a very natural appearance, wherein the intermittent pattern is deposited on the lens surface by the steps of:
a) providing a first plate having depressions corresponding to the first portion;
b) filling the depressions with colorant of the first shade;
c) pressing a first flexible pad against the first plate;
d) pressing the first flexible pad against a surface of the lens thereby printing the first portion of the elements;
e) providing a second plate having depressions corresponding to the second portion;
f) filling in the depressions with colorant of the second shade;
g) pressing a second flexible pad against a second plate;
h) pressing the second flexible pad against said surface of the lens thereby printing the second portion of the elements;
i) providing a third plate having depressions corresponding to the third portion;
j) filling the depressions with colorant of the third shade;
k) pressing a third flexible pad against a third plate; and
l) pressing the third flexible pad against said surface of the lens thereby printing the third portion of the elements.

19. The method for manufacturing a colored contact lens in accordance with claim 18 wherein the three portions of colorant cover at least about 50% of the surface of the iris section lens.

20. The method for manufacturing a colored contact lens in accordance with claim 18 wherein the three portions of colorant cover at least about 60% of the surface of the iris section of the lens.

21. The method for manufacturing a colored contact lens in accordance with claim 18 wherein the portions of colorant cover up to 80% of the surface of the iris section of the lens.

22. The method for manufacturing a colored contact lens in accordance with claim 18 wherein the colored contact lens is hydrophilic.

23. The method for manufacturing a colored contact lens in accordance with claim 18 wherein one or more of the portions of colorant are transparent.

24. The method for manufacturing a colored contact lens in accordance with claim 18 wherein said first shade is black, said second shade is a color selected from the group consisting of blue, green, gray or brown, and said third shade is hazel.

25. A colored contact lens comprising a non-opaque pupil section, an iris section surrounding said pupil section, and a colored, opaque intermittent pattern over said entire iris section, said pattern covering at least about 25% of the area of said iris section, the elements of said pattern being indiscernible to the ordinary viewer, wherein a first portion of the elements of said pattern is a first shade, a second portion of the elements of said pattern is a second shade different from said first shade, and a third portion of the elements of said pattern is a third shade different from said second shade and either the same or different from said first shade, wherein said first portion, an outermost starburst, is located generally on the outside of said iris section and generally on the outside of said second portion, and said second portion, an outer starburst, is located generally on the inside of said first portion, and said third portion, an inner starburst, is located generally on the inside of said second portion of said iris section, and a first uneven border differentiates said outermost starburst and said outer starburst, and a second uneven border differentiates said outer starburst and said inner starburst, such that said outermost starburst overlaps said outer starburst at a plurality of locations, and said outer starburst overlaps said inner starburst at a plurality of locations, thereby providing a lens capable of changing the apparent color of the iris of a person wearing the lens and imparting a very natural appearance.

26. The colored contact lens in claim 25, wherein said outer starburst comprises an annular ring having an outer and inner border being substantially circular.

27. A colored contact lens comprising a non-opaque pupil section, an iris section surrounding said pupil section, and a colored, opaque intermittent pattern over said entire iris section that leaves a substantial portion within the interstices of the pattern non-opaque, said pattern covering at least about 25% of the area of said iris section, the elements of said pattern being indiscernible to the ordinary viewer, wherein a first portion of the elements of said pattern is a first shade, a second portion of the elements of said pattern is a second shade different from said first shade, and a third portion of the elements of said pattern is a third shade different from said second shade and either the same or different from said first shade, wherein said first portion is located generally on the outside of said iris section, and said second portion is located generally on the inside of said first portion, and said third portion is located generally on the inside of said second portion of said iris section, and a first uneven border differentiates said first and second portions, wherein the minimum distance of said first uneven border from the outer perimeter of said iris section is from about 5% to about 50% of the radial width of said iris section, and the maximum distance of said first uneven border from the outer perimeter of said iris section is from about 50% to about 85% of the radial width of said iris section, and a second uneven border differentiates said second and third portions, wherein the minimum distance of said second uneven border from the outer perimeter of said iris section is from about 15% to about 50% of the radial width of said iris section, and the maximum distance of said second uneven border from the outer perimeter of said iris section is from about 50% to about 95% of the radial width of said iris section, such that said first portion overlaps said second portion at a plurality of locations, and said second portion overlaps said third portion at a plurality of locations, thereby providing a lens capable of changing the apparent color of the iris of a person wearing the lens and imparting a very natural appearance.

28. A colored contact lens having three substantially annular concentric zones, a first color zone, a second color zone, and a third color zone, comprising;
a) said first color zone located interior to said second color zone and said third color zone, said first color zone having a starburst pattern such that a plurality of digits extend radially outward, such that the first color zone shares a radial area with the second color zone, wherein the digits of the first color zone and the second color zone are interdigitated, and do not overlap;
b) said second color zone situated between the first color zone and the third color zone, having an annular pattern such that a plurality of digits extend radially inward in the direction of the first color zone, and radially outward in the direction of the third color zone, such that the second color zone shares a radial area with the first color zone and with the third color zone, wherein the colors of the first color zone and the second color zone are interdigitated, and do not overlap, and the digits of the second color zone and the third color zone are interdigitated, and do not overlap;
c) said third color zone situated substantially exterior to both the second color zone and the first color zone, having an annular pattern such that a plurality of digits extend radially inward in the direction of the second color zone, such that the third color zone shares a radial area with the second color zone, wherein the digits of the first color zone and the second color zone are interdigitated, and do not overlap.

29. The contact lens of claim 28 wherein the digits of the first color zone share a radial area with the digits of the third color zone.

30. The contact lens of claim 29 wherein the digits of the third color zone share a radial area with the digits of the first color zone.

31. The contact lens of claim 30 further comprising a fourth zone having substantially the same color as the second color zone, said fourth zone extending radially outward from said third color zone, wherein said fourth zone shares a jagged border with the third color zone.

32. The contact lens of claim 31 wherein the colorant of the third color zone becomes lighter as the digits extend radially inward.

33. The colored contact lens in accordance with claim 1 wherein the elements of the pattern are dots.

34. The colored contact lens in accordance with claim 2 wherein the elements of the pattern are dots.

35. The colored contact lens in accordance with claim 1 wherein the elements of the pattern are not uniform, thereby allowing enhancement of the fine structure of the iris.

36. The colored contact lens in accordance with claim 2 wherein the elements of the pattern are not uniform, thereby allowing enhancement of the fine structure of the iris.

37. A colored contact lens in accordance with claim 1 wherein said first shade is the same shade as said third shade.

38. A colored contact lens in accordance with claim 2 wherein said first shade is the same shade as said third shade.
